(19) United States
(12) Patent Application Publication
(10) Pub. No.: US 2021/0126257 A1
(43) Pub. Date: Apr. 29, 2021

(54) NEGATIVE ELECTRODE FOR LITHIUM-ION BATTERY OF TERMINAL DEVICE

(71) Applicant: BEIJING XIAOMI MOBILE SOFTWARE CO., LTD., Beijing (CN)

(72) Inventor: Zhiming HE, Beijing (CN)

(73) Assignee: BEIJING XIAOMI MOBILE SOFTWARE CO., LTD., Beijing (CN)

(21) Appl. No.: 16/854,574

(22) Filed: Apr. 21, 2020

(30) Foreign Application Priority Data
Oct. 29, 2019 (CN) 201911039621.X

(51) Int. Cl. H01M 4/587; H01M 10/0525; H01M 4/36; H01M 4/04

(52) U.S. Cl. CPC H01M 4/587; H01M 10/0525; H01M 2004/027; H01M 4/0404; H01M 4/366

(57) ABSTRACT

The disclosure provides a negative electrode for a lithium-ion battery of a terminal device. The negative electrode for the lithium-ion battery can include a current collector and at least two graphite layers. The at least two graphite layers with different capacity densities cover a surface of the current collector in a stacked manner.

### CROSS-REFERENCE TO RELATED APPLICATIONS

This application is based upon and claims priority to Chinese Patent Application 201911039621.X, filed on Oct. 29, 2019, the entire content of which is incorporated herein by reference.

### TECHNICAL FIELD

The disclosure relates to the technical field of terminal devices, and more particularly, to a negative electrode for a lithium-ion battery of a terminal device.

### BACKGROUND

As a terminal device tends to be miniaturized and on standby for a long time, a battery of the terminal device is generally of a high energy density. Taking a lithium-ion battery as an example, by increasing a capacity density of a negative electrode for the lithium-ion battery, an energy density of the lithium-ion battery can be increased, but a charging speed of the lithium-ion battery is reduced. That is to say, charging time is extended, which cannot meet user requirements.

### SUMMARY

It can be important to improve a capacity density of a negative electrode of a lithium-ion battery, and therefore the energy density of the lithium-ion battery, while a charging time is ensured. According, an aspect of the disclosure can provide a negative electrode for a lithium-ion battery. The negative electrode for the lithium-ion battery can include a current collector, and at least two graphite layers with different capacity densities for covering a surface of the current collector in a stacked manner.

Another aspect of the disclosure provides a method for preparing a negative electrode for a lithium-ion battery. The method for preparing the negative electrode for the lithium-ion battery can include acquiring a current collector, and coating at least two graphite layers with different capacity densities on a surface of the current collector.

According to another aspect of the disclosure, the disclosure provides a lithium-ion battery. The lithium-ion battery includes: the negative electrodes for the lithium-ion battery mentioned above, a positive electrode and an electrolyte.

According to another aspect of the disclosure, the disclosure provides a terminal device. The terminal device includes: the lithium-ion battery mentioned above, a power switch, and a display.

### BRIEF DESCRIPTION OF THE DRAWINGS

The accompanying drawings, which are incorporated in the specification and constitute a part of the specification, show embodiments of the present disclosure. The drawings along with the specification explain the principles of the present disclosure.

FIG. 1 is a structural diagram of a negative electrode for a lithium-ion battery.

FIG. 2 is a structural diagram of a negative electrode for a lithium-ion battery according to an exemplary embodiment of the disclosure.

FIG. 3 is a structural diagram of a negative electrode for a lithium-ion battery according to another exemplary embodiment of the disclosure.

FIG. 4 is a flow chart showing a method for preparing a negative electrode for a lithium-ion battery according to the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

The terms used in the disclosure are for the purpose of describing specific embodiments only and are not intended to limit the disclosure. Unless otherwise defined, the technical terms or scientific terms used in the disclosure shall have the general meaning understood by those skilled in the art to which the disclosure belongs. “First”, “second” and similar words used in the description and claims of the disclosure do not indicate any order, quantity or importance, but are only used to distinguish different components. Similarly, words such as “one” or “a/an” do not indicate any quantity limitation, but the existence of at least one. Unless otherwise pointed out, words such as “comprise” or “include” mean that the components or objects appearing before “comprise” or “include” cover the components or objects listed after “comprise” or “include” and their equivalents, without excluding other components or objects. Words such as “connect” or “connected” are not limited to physical or mechanical connections, and may include electrical connections, whether direct or indirect.

The singular form “one”, “said” and “the” used in the description and the appended claims of the disclosure are also intended to include the plural forms, unless otherwise the context clearly indicates other meanings. It should also be understood that the term “and/or” as used herein refers to and includes any or all possible combinations of one or more associated listed items.

As a terminal device tends to be miniaturized and required to be on standby for a long time, it is necessary to make a lithium-ion battery of the terminal device have a higher energy density. In other words, energy stored by the battery per unit volume need to increase higher and higher. The energy density of the lithium-ion battery can be increased by increasing a capacity density of the negative electrode for the lithium-ion battery. The capacity density refers to a capacity of the battery per unit volume, in mAh/cm³. The unit of the energy density is Wh/cm³. The energy density is obtained by multiplying the capacity density by voltage platform (energy density=capacity density*voltage platform), and the unit of the voltage platform is V. Generally, the negative electrode for the lithium-ion battery includes graphite layers. When the capacity density of the graphite layers increases, a charging rate of the lithium-ion battery decreases, that is, a charging speed decreases.

In order to solve the above problem, an embodiment of the disclosure provides a negative electrode for a lithium-ion battery, which includes a current collector and at least two graphite layers. The at least two graphite layers cover a surface of the current collector in a stacked manner, and capacity densities of the at least two graphite layers are different. In the negative electrode for the lithium-ion battery provided by the embodiment of the disclosure, by covering the current collector with the at least two graphite layers with different capacity densities in a stacked manner, an average capacity density of the negative electrode for the lithium-ion battery can be enabled to be greater than the lowest capacity density of the plurality of graphite layers, such as the capacity density of the graphite layer in the related art, when charging time is ensured, thereby improving the capacity density of the negative electrode for the lithium-ion battery, improving an energy density of the lithium-ion battery, and reducing the volume of the lithium-ion battery.

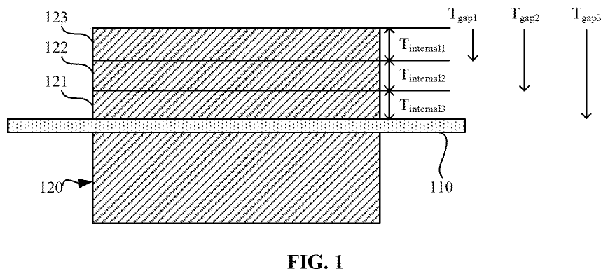

FIG. 1 is a structural diagram of a negative electrode for a conventional lithium-ion battery. Referring to FIG. 1, the negative electrode for the lithium-ion battery includes a current collector 110 and a graphite layer 120 covering the current collector 110. The graphite layer 120 is a single-layer graphite layer, and the capacity density is low and is 450-630 mAh/cm³.

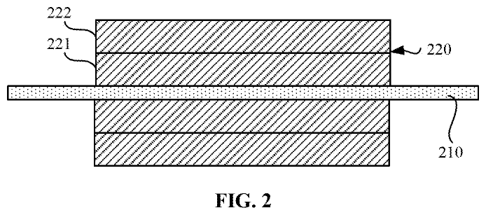

When the charging time of the negative electrode for the lithium-ion battery is the same as that in the conventional art, in order to improve the energy density of the negative electrode for the lithium-ion battery, an embodiment of the disclosure provides a negative electrode for a lithium-ion battery. FIG. 2 is a structural diagram of a negative electrode for a lithium-ion battery according to an embodiment of the disclosure. Referring to FIG. 2, the negative electrode for the lithium-ion battery includes a current collector 210 and at least two graphite layers 220. The at least two graphite layers 220 cover a surface of the current collector 210 in a stacked manner, and capacity densities of the at least two graphite layers 220 are different.

It should be noted that the capacity density in embodiments of the disclosure is a volume capacity density, and an energy density is a volume energy density. The lowest capacity density of the at least two graphite layers 220 may be the capacity density of the graphite layer 120 in the conventional art.

In the negative electrode for the lithium-ion battery in the embodiment of the disclosure, by covering the current collector 210 with at least two graphite layers 220 with different capacity densities in a stacked manner, an average capacity density of the negative electrode for the lithium-ion battery can be enabled to be greater than the lowest capacity density of the at least two graphite layers 220, i.e., the capacity density of the graphite layer 120 in the related art, when the charging time is ensured, thereby improving the capacity density of the negative electrode for the lithium-ion battery, improving an energy density of the lithium-ion battery, and reducing the volume of the lithium-ion battery.

In an embodiment, also referring to FIG. 2, the at least two graphite layers 220 include an innermost graphite layer 221 in contact with the current collector 210 and at least one non-innermost graphite layer 222 facing away from the current collector 210. A capacity density of the at least one non-innermost graphite layer 222 is greater than a capacity density of the innermost graphite layer 221. In an embodiment, the capacity density of the innermost graphite layer 221 is the lowest, and the capacity density of the innermost graphite layer 221 ranges from 450 to 630 mAh/cm³. For example, it may be 450 mAh/cm³, 470 mAh/cm³, 500 mAh/cm³, 520 mAh/cm³, 540 mAh/cm³, 550 mAh/cm³, 570 mAh/cm³, 580 mAh/cm³, 600 mAh/cm³, 630 mAh/cm³, and the like. In some embodiments, the capacity density of the innermost graphite layer 221 is equal to that of the graphite layer 120 in the conventional art, so that the capacity density of the negative electrode for the lithium-ion battery is greater than the value among 450-630 mAh/cm³ when the charging time of the lithium-ion battery remains unchanged.

When the lithium-ion battery is charged, lithium ions are de-intercalated from a positive electrode, diffused to and intercalated in the position between the graphite layers 220 of the negative electrode. When all lithium ions are intercalated in the position between the graphite layers 220, the charging is completed, and spent time is the charging time of the lithium-ion battery. The “time for lithium ion intercalation” in embodiments of the disclosure refers to the time that the corresponding graphite layer 220 is completely intercalated with lithium ions in the lithium-ion battery, which may also be understood as the diffusion time of lithium ions in the graphite layers 220, or charging time of the graphite layers 220. The time for lithium ion intercalation in the graphite layers 220 includes: diffusion time T_{gap} of lithium ions in gaps between graphite particles plus diffusion time Tᵢₙₜₑᵣₙₐₗ of lithium ions in graphite particles.

The time for lithium ion intercalation in graphite layers will be further explained below.

Referring to FIG. 1, the graphite layer 120 is divided into an innermost graphite layer 121, a middle graphite layer 122 and an outermost graphite layer 123 in a direction far from the current collector 110. When lithium ions are diffused from the outside to the inside, the diffusion time of lithium ions in gaps between the graphite particles gradually increases, that is, diffusion time T_{gap1} of lithium ions in gaps between graphite particles of the outermost graphite layer 123 less than diffusion time T_{gap2} of lithium ions from an outer surface of the graphite layer 120 to gaps between graphite particles of the middle graphite layer 122 less than diffusion time T_{gap3} of lithium ions from the outer surface of the graphite layer 120 to gaps between graphite particles of the innermost graphite layer 121 (T_{gap1}<T_{gap2}<T_{gap3}). When the thicknesses of the innermost graphite layer 121, the middle graphite layer 122 and the outermost graphite layer 123 are identical, since the capacity densities of the three graphite layers are identical, diffusion time Tᵢₙₜₑᵣₙₐₗ₁ of lithium ions in graphite particles of the outermost graphite layer 123, diffusion time Tᵢₙₜₑᵣₙₐₗ₂ of lithium ions in graphite particles of the middle graphite layer 122 and diffusion time Tᵢₙₜₑᵣₙₐₗ₃ of lithium ions in graphite particles of the innermost graphite layer 121 are equal. Then, the charging time of the graphite layer 120 is the time for lithium ion intercalation in the last graphite layer, that is, the time Tᵢₙₜₑᵣₙₐₗ₃ for lithium ion intercalation in the innermost graphite layer 121 plus T_{gap3}.

In an embodiment, time for lithium ion intercalation in the non-innermost graphite layer 222 is less than or equal to time for lithium ion intercalation in the innermost graphite layer 221. In some embodiments, it is easy to ensure that the charging time of the lithium-ion battery is unchanged, and it improves the capacity density of the negative electrode for the lithium-ion battery. A specific explanation will be made below.

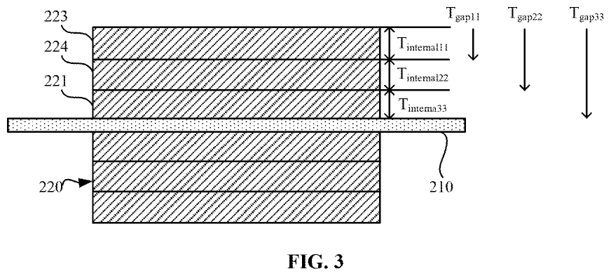

FIG. 3 is a structural diagram of a negative electrode for a lithium-ion battery according to another embodiment of the disclosure. Referring to FIG. 3, the graphite layers 220 include an outermost graphite layer 223, a middle graphite layer 224, and the innermost graphite layer 221. Since the radius of each lithium ion is at a nanometer scale and the size of gaps between graphite particles is at a micron scale, different compacted density and different particle sizes of graphite particles have little influence on the diffusion speed of lithium ions in gaps between graphite particles, which can be ignored. The diffusion time of lithium ions in gaps between the graphite particles gradually increases from the outside to the inside, that is, diffusion time T_{gap1} of lithium ions in gaps between graphite particles of the outermost graphite layer 223 less than diffusion time T_{gap22} of lithium ions from an outer surface of the graphite layer 220 to gaps between graphite particles of the middle graphite layer 224 less than diffusion time T_{gap33} of lithium ions from the outer surface of the graphite layer 220 to gaps between graphite particles of the innermost graphite layer 221 (T_{gap11}<T_{gap22}<T_{gap33}). When the total thickness of the graphite layer 220 in the embodiment is equal to the total thickness of the graphite layer 120 in the related art, the diffusion time T_{gap33} of lithium ions from the surface of the graphite layer 220 to gaps between graphite particles of the innermost graphite layer 221 is equal to the diffusion time T_{gap3} (T_{gap33}=T_{gap3}).

If an energy density of the outermost graphite layer 223 in FIG. 3 is greater than that of the middle graphite layer 224 or the innermost graphite layer 221, diffusion of lithium ions in the outermost graphite layer 223 is slower, and diffusion time is the sum of Tᵢₙₜₑᵣₙₐₗ₁ and T_{gap11} which is greater than the sum of Tᵢₙₜₑᵣₙₐₗ₁ and T_{gap1} (Tᵢₙₜₑᵣₙₐₗ₁₁+T_{gap11}>Tᵢₙₜₑᵣₙₐₗ₁+T_{gap1}). When the total thickness of the graphite layers 220 in FIG. 3 is equal to that of the graphite layer 120 in FIG. 1, and when the thickness of the innermost graphite layer 221 is equal to that of the innermost graphite layer 121 in FIG. 1 and those capacity densities are also identical, diffusion time of lithium ions in the innermost graphite layer 221 is the sum of Tᵢₙₜₑᵣₙₐₗ₃₃ and T_{gap33} which is equal to the sum of Tᵢₙₜₑᵣₙₐₗ₃ and T_{gap3} (Tᵢₙₜₑᵣₙₐₗ₃₃+T_{gap33}=Tᵢₙₜₑᵣₙₐₗ₃+T_{gap3}). By making the sum of Tᵢₙₜₑᵣₙₐₗ₃₃ and T_{gap33} greater than the sum of Tᵢₙₜₑᵣₙₐₗ₁ and T_{gap1} and also less than or equal to the sum of Tᵢₙₜₑᵣₙₐₗ₃₃ and T_{gap33} which is equal to the sum of Tᵢₙₜₑᵣₙₐₗ₃ and T_{gap3} (Tᵢₙₜₑᵣₙₐₗ₁+T_{gap1}<Tᵢₙₜₑᵣₙₐₗ₁₁+Tᵢₙₜₑᵣₙₐₗ₁<Tᵢₙₜₑᵣₙₐₗ₃₃+T_{gap33}=Tᵢₙₜₑᵣₙₐₗ₃+T_{gap3}), the charging time of the lithium-ion battery with the negative electrode illustrated in FIG. 3 is the sum of Tᵢₙₜₑᵣₙₐₗ₃₃ and T_{gap33} (Tᵢₙₜₑᵣₙₐₗ₃₃+T_{gap33}), so as to ensure that the charging time is unchanged. It should be noted that the relationship between the diffusion time (the sum of Tᵢₙₜₑᵣₙₐₗ₁₁ and T_{gap11}) of lithium ions in the outermost graphite layer 223 and the diffusion time (the sum of Tᵢₙₜₑᵣₙₐₗ₂₂ and T_{gap22}) of lithium ions in the middle graphite layer 224 is not limited, but it is necessary to meet requirements: the sum of Tᵢₙₜₑᵣₙₐₗ₁₁ and T_{gap11} is less than the sum of Tᵢₙₜₑᵣₙₐₗ₃₃ and T_{gap33} (Tᵢₙₜₑᵣₙₐₗ₁+T_{gap11}<Tᵢₙₜₑᵣₙₐₗ₃₃+T_{gap33}), and the sum of Tᵢₙₜₑᵣₙₐₗ₂₂ and T_{gap22} is less than the sum of Tᵢₙₜₑᵣₙₐₗ₃₃ and T_{gap33} (Tᵢₙₜₑᵣₙₐₗ₂₂+T_{gap22}<Tᵢₙₜₑᵣₙₐₗ₃₃+T_{gap33}), so as to ensure that the charging time is the sum of Tᵢₙₜₑᵣₙₐₗ₃₃ and T_{gap33} (Tᵢₙₜₑᵣₙₐₗ₃₃+T_{gap33}).

In an embodiment, the thicknesses of the innermost graphite layer 221, the middle graphite layer 224 and the outermost graphite layer 223 are not necessarily equal, and the proportion of the three graphite layers needs to be balanced based on the charging time, so as to ensure that the charging time of the lithium-ion battery is unchanged.

In an embodiment, the capacity densities of the at least two graphite layers 220 gradually increase in a direction far away from the current collector 210. In some embodiments, the charging time of the lithium-ion battery with the graphite layers 220 can be easily controlled, and the average capacity density of the negative electrode for the lithium-ion battery can be increased.

In an embodiment, at least one group of a capacity per gram, a compacted density or a graphite particle median diameter of the at least two graphite layers 220 gradually increases in a direction far away from the current collector 210, so that the capacity densities of the plurality of graphite layers 220 gradually increase in a direction far away from the current collector 210. The capacity density is obtained by multiplying the capacity per gram by compacted density. The capacity per gram refers to the ratio of electric capacity released by active substances inside the battery to the mass of the active substances. The larger the gram capacity, the higher the capacity density of the graphite layers 220. The higher the compacted density, the higher the content of graphite per unit volume and the higher the capacity density of the graphite layers 220. The larger the median diameter of graphite particles, the larger the particle size of graphite particles, the more the lithium ions intercalated in the graphite particles, and the higher the capacity density of the graphite particles.

In an embodiment, the capacity per gram of each of the graphite layers 220 ranges from 300 to 365 mAh/g. For example, it may be 300 mAh/g, 310 mAh/g, 320 mAh/g, 330 mAh/g, 340 mAh/g, 350 mAh/g, 360 mAh/g, 365 mAh/g, etc. In some embodiments, by controlling the capacity per gram of each of the graphite layers 220, it is easy to enable the capacity densities of the plurality of graphite layers 220 to gradually increase in a direction far away from the current collector 210.

In an embodiment, the compacted density of each of the graphite layers 220 ranges from 1.55 to 1.85 g/cm³. For example, it may be 1.55 g/cm, 1.6 g/cm³, 1.65 g/cm³, 1.7 g/cm³, 1.75 g/cm³, 1.8 g/cm³, 1.85 g/cm³, etc. In some embodiments, by controlling the compacted density of each of the graphite layers 220, it is easy to enable the capacity densities of the plurality of graphite layers 220 to gradually increase in a direction far away from the collector 210.

In an embodiment, the graphite particle median diameter of each of the graphite layers 220 ranges from 5 to 25 μm. For example, it may be 5 μm, 8 μm, 10 μm, 13 μm, 15 μm, 17 μm, 20 μm, 22 μm, 25 μm, etc. In some embodiments, by controlling the graphite particle median diameter of each of the graphite layers 220, it is easy to enable the capacity densities of the graphite layers 220 to gradually increase in a direction far away from the current collector 210.

In an embodiment, the thickness of each of the graphite layers 220 ranges from 1 to 80 μm. For example, it may be 1 μm, 7 μm, 10 μm, 17 μm, 20 μm, 25 μm, 30 μm, 35 μm, 40 μm, 45 μm, 50 μm, 55 μm, 60 μm, 65 μm, 70 μm, 75 μm, 80 μm, etc. The surface density of each of the graphite layers 220 ranges from 0.001 g/cm² to 0.3 g/cm². For example, it may be 0.001 g/cm², 0.01 g/cm², 0.1 g/cm², 0.15 g/cm², 0.2 g/cm², 0.25 g/cm², 0.3 g/cm², etc. In some embodiments, by setting the thickness and surface density of each of the graphite layers 220, the graphite layers 220 can be conveniently prepared, and the negative electrode for the lithium-ion battery also has the good capacity density.

In an embodiment, the number of the graphite layers 220 is two, the capacity per gram of the innermost graphite layer 221 ranges from 300 to 360 mAh/g, its compacted density ranges from 1.55 to 1.75 g/cm³, its graphite particle median diameter ranges from 5 to 20 μm, its thickness ranges from 1 to 80 μm, and its surface density ranges from 0.001 to 0.015 g/cm². The capacity per gram of the outermost graphite layer 223 ranges from 320 to 365 mAh/g, its compacted density ranges from 1.60 to 1.85 g/cm³, its graphite particle median diameter ranges from 10 to 25 μm, its thickness ranges from 1 to 80 μm, and its surface density ranges from 0.001 to 0.015 g/cm². In some embodiments, the capacity per gram of the graphite layer of the negative electrode for the lithium-ion battery in the related art is 300-360 mAh/g, its compacted density is 1.55-1.75 g/cm, and its graphite particle median diameter is 5-20 μm, and its thickness is identical with that of the graphite layer 220 in embodiments of the disclosure. The average capacity density of the negative electrode for the lithium-ion battery in embodiments of the disclosure is 3%-5% greater than the capacity density of the negative electrode for the lithium-ion battery in the related art.

In an embodiment, the graphite layers 220 include the innermost graphite layer 221, a middle graphite layer 224 and the outermost graphite layer 223. The time for lithium ion intercalation in the outermost graphite layer 223 or the time for lithium ion intercalation in the middle graphite layer 224 is less than or equal to the time for lithium ion intercalation in the innermost graphite layer 221. The thickness ratio of the innermost graphite layer 221, the middle graphite layer 224 and the outermost graphite layer 223 needs to be balanced to ensure that the time for lithium ion intercalation in the graphite layers 220 is unchanged. In an embodiment, the capacity per gram of the innermost graphite layer 221 may range from 300 to 320 mAh/g, its compacted density may range from 1.55 to 1.75 g/cm³, its graphite particle median diameter may range from 5 to 15 μm, its thickness may range from 1 to 80 μm, and its surface density may range from 0.001 to 0.015 g/cm². The capacity per gram of the middle graphite layer 224 may range from 320 to 345 mAh/g, its compacted density may range from 1.60 to 1.80 g/cm³, its graphite particle median diameter may range from 10 to 20 μm, its thickness may range from 1 to 80 μm, and its surface density may range from 0.02 to 0.035 g/cm². The capacity per gram of the outermost graphite layer 223 may range from 340 to 365 mAh/g, its compacted density may range from 1.65 to 1.85 g/cm³, its graphite particle median diameter may range from 15 to 25 μm, its thickness may range from 1 to 80 μm, and its surface density may range from 0.04 to 0.095 g/cm².

In an embodiment, the graphite layers 220 cover two opposite surfaces of the current collector 210, so as to improve the utilization rate of space.

In an embodiment, the graphite layers 220 include at least one of natural graphite, artificial graphite or modified graphite; and/or the current collector 210 includes a copper foil or aluminum foil.

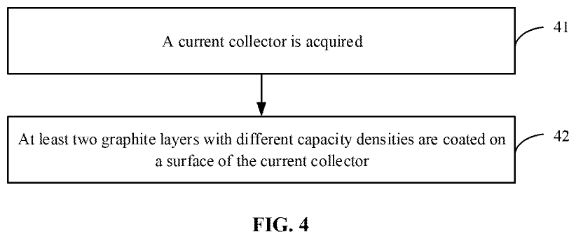

FIG. 4 is a flow chart showing a method for preparing a negative electrode for a lithium-ion battery according to the disclosure. The embodiment of the disclosure further provides a method for preparing any one of the negative electrodes for the lithium-ion battery mentioned above. Referring to FIG. 4, the method can include the following steps.

In step 41, a current collector 210 is acquired. After the current collector 210 is acquired, the current collector 210 may be cleaned and polished. The current collector 210 may be a copper foil or aluminum foil.

In step 42, at least two graphite layers 220 with different capacity densities are coated on a surface of the current collector 210. In an embodiment, when each of the graphite layers 220 is coated, graphite particles are mixed with a conductive agent and a binder to form slurry, which is then coated on the current collector 210. The conductive agent includes at least one of acetylene black, conductive carbon black, carbon fiber, carbon nanotube, Ketjen black or graphite conductive agent. The binder includes at least one of polyvinyl alcohol, polytetrafluoroethylene, polyolefin, polyvinylidene fluoride, styrene butadiene rubber, fluorinated rubber, polyurethane, or hydroxymethyl cellulose salt.

In an embodiment, an innermost graphite layer 221 is coated on the surface of the current collector 210 by adopting a gravure coating process or extrusion coating process and is dried, and then other non-innermost graphite layers 222 are coated on a surface of the innermost graphite layer 221 by adopting the gravure coating process or extrusion coating process and are dried, until the multilayer graphite layers 220 are completely coated on the surface of the current collector 210.

An embodiment of the disclosure further provides a lithium-ion battery, which includes: a positive electrode, an electrolyte any one of the negative electrodes for the lithium-ion battery mentioned above. In some embodiments, an energy density of the lithium-ion battery is improved when charging time remains unchanged.

Another embodiment of the disclosure further provides a method for preparing a lithium-ion battery. The method includes: performing processes such as cold pressing, slitting, winding or laminating, case welding, sealing, electrolyte injection, formation, sorting, assembly and the like to a negative electrode, a separator and a positive electrode for the lithium-ion battery which are stacked, so as to obtain the lithium-ion battery in the embodiments of the disclosure.

A further embodiment of the disclosure further provides a terminal device, which includes: the lithium-ion battery mentioned above, a power switch, and a display. The terminal device may be a mobile phone, a digital broadcasting terminal, a message receiving and sending device, a game console, a tablet device, medical equipment, fitness equipment, a personal digital assistant, and the like.

For the method embodiment, since it basically corresponds to the device embodiment, reference may be made to the part of the description of the device embodiment for relevant points. The method embodiment and the device embodiment are complementary to each other.

The embodiments described above are just preferred embodiments of the disclosure and are not used to limit the disclosure. Any modification, equivalent replacement, improvement and the like made within the spirit and principle of the disclosure shall be included in the protection scope of the disclosure.

What is claimed is:

1. A negative electrode for a lithium-ion battery, comprising:
a current collector; and
at least two graphite layers with different capacity densities for covering a surface of the current collector in a stacked manner.

2. The negative electrode for the lithium-ion battery of claim 1, wherein the at least two graphite layers further comprise an innermost graphite layer in contact with the current collector and at least one non-innermost graphite layer facing away from the current collector, and a capacity density of the at least one non-innermost graphite layer is greater than a capacity density of the innermost graphite layer.

3. The negative electrode for the lithium-ion battery of claim 2, wherein the capacity densities of the at least two graphite layers gradually increase in a direction away from the current collector.

4. The negative electrode for the lithium-ion battery of claim 3, wherein at least one group of a capacity per gram, a compacted density, or a graphite particle median diameter of the at least two graphite layers gradually increases in the direction away from the current collector.

5. The negative electrode for the lithium-ion battery of claim 4, wherein:
the capacity per gram of each of the graphite layers ranges from 300 to 365 mAh/g,
the compacted density of each of the graphite layers ranges from 1.55 to 1.85 g/cm³, and
the graphite particle median diameter of each of the graphite layers ranges from 5 to 25 μm.

6. The negative electrode for the lithium-ion battery of claim 2, wherein the capacity density of the innermost graphite layer is at a lowest level of the graphite layer, and the capacity density of the innermost graphite layer ranges from 450 to 630 mAh/cm³.

7. The negative electrode for the lithium-ion battery of claim 2, wherein a time for lithium ion intercalation in the non-innermost graphite layer is less than or equal to a time for lithium ion intercalation in the innermost graphite layer.

8. The negative electrode for the lithium-ion battery of claim 1, wherein:
a thickness of each of the graphite layers ranges from 1 to 80 μm, and
a surface density of each of the graphite layers ranges from 0.001 g/cm² to 0.3 g/cm².

9. The negative electrode for the lithium-ion battery of claim 1, the at least two graphite layers cover two opposite surfaces of the current collector.

10. A method for preparing a negative electrode for a lithium-ion battery, comprising:
acquiring a current collector; and
coating at least two graphite layers with different capacity densities on a surface of the current collector.

11. A lithium-ion battery comprising:
a negative electrode having a current collector and at least two graphite layers with different capacity densities for covering a surface of the current collector in a stacked manner;
a positive electrode; and
an electrolyte.

12. The lithium-ion battery of claim 11, wherein the at least two graphite layers further comprise an innermost graphite layer in contact with the current collector and at least one non-innermost graphite layer facing away from the current collector, and a capacity density of the at least one non-innermost graphite layer is greater than a capacity density of the innermost graphite layer.

13. The lithium-ion battery of claim 12, wherein the capacity densities of the at least two graphite layers gradually increase in a direction far away from the current collector.

14. The lithium-ion battery of claim 13, wherein at least one group of a capacity per gram, a compacted density, or a graphite particle median diameter of the at least two graphite layers gradually increases in a direction away from the current collector.

15. The lithium-ion battery of claim 14, wherein:
the capacity per gram of each of the graphite layers ranges from 300 to 365 mAh/g;
the compacted density of each of the graphite layers ranges from 1.55 to 1.85 g/cm³; and
the graphite particle median diameter of each of the graphite layers ranges from 5 to 25 μm.

16. The lithium-ion battery of claim 12, wherein the capacity density of the innermost graphite layer is a lowest level, and the capacity density of the innermost graphite layer ranges from 450 to 630 mAh/cm³.

17. The lithium-ion battery of claim 12, wherein a time for lithium ion intercalation in the non-innermost graphite layer is less than or equal to a time for lithium ion intercalation in the innermost graphite layer.

18. The lithium-ion battery of claim 11, wherein:
a thickness of each of the graphite layers ranges from 1 to 80 μm, and
a surface density of each of the graphite layers ranges from 0.00 g/cm² to 0.3 g/cm².

19. The lithium-ion battery of claim 11, the at least two graphite layers cover two opposite surfaces of the current collector.

20. A terminal device, comprising the lithium-ion battery of claim 11, a power switch, and a display.
